(19) United States
(12) Patent Application Publication
(10) Pub. No.: US 2026/0030579 A1
(43) Pub. Date: Jan. 29, 2026

(54) Automated Workflow Management System Triggered by Email Recipient Fields

(71) Applicant: Michael David Fodera, Hanson, MA (US)

(72) Inventor: Michael David Fodera, Hanson, MA (US)

(21) Appl. No.: 19/020,223

(22) Filed: Jan. 14, 2025

(51) Int. Cl. G06Q 10/0633; G06Q 10/107; H04L 9/40

(52) U.S. Cl. CPC G06Q 10/0633; G06Q 10/107; H04L 63/105

(57) ABSTRACT

The present invention, BCCBuddy, is an automated workflow management system that dynamically triggers multi-step workflows using email recipient fields (To, CC, and BCC). Unlike traditional automation tools relying on static triggers or basic email parsing, BCCBuddy executes multiple workflows simultaneously, each mapped to distinct recipient fields. The system incorporates advanced email parsing, a configurable storage system for workflow mapping, and optional data enrichment through natural language processing (NLP). By integrating seamlessly with third-party platforms such as CRM, task management, and scheduling tools, the invention supports high-volume email processing and complex automation scenarios. Its intuitive design ensures accessibility for technical and non-technical users alike, eliminating the need to modify email content or user behavior. BCCBuddy redefines email-driven automation by streamlining workflows, reducing manual effort, and enhancing productivity across industries and applications.

### CROSS-REFERENCE TO RELATED APPLICATIONS

Not applicable. There are no related applications, and no provisional application was filed.

### STATEMENT REGARDING FEDERALLY SPONSORED RESEARCH

Not applicable. The invention was not developed with federal funding.

### FIELD

The present invention relates to workflow automation systems, and more particularly, to a method and system for dynamically triggering multi-step workflows based on email recipient fields, including the To, CC (carbon copy), and BCC (blind carbon copy) fields. The invention enables users to initiate and manage workflows seamlessly by leveraging predefined email addresses as triggers within recipient fields, including the BCC field for invisible, behind-the-scenes workflow initiation, transforming email into a central tool for scalable and flexible automation.

### BACKGROUND OF THE INVENTION

Email remains a cornerstone of modern communication and business operations. However, its potential as a trigger for initiating complex, multi-step workflows has not been fully realized. Existing workflow automation solutions predominantly rely on static triggers, such as keywords in the subject line, email body, or specific metadata, which are rigid and fail to adapt to evolving business requirements.

Traditional systems rely heavily on predefined email content or rigid rules, making them inflexible and incapable of handling dynamic workflows tailored to real-time user needs. This reliance on static triggers significantly limits their applicability in scenarios requiring adaptability or scalability.

Conventional systems also exhibit limited functionality, as they are typically designed to execute isolated tasks, such as forwarding an email or scheduling a single calendar event. These systems cannot support multi-step workflows or parallel processing, further reducing their utility in complex automation scenarios.

Recipient fields, such as To, CC, and BCC, are rarely leveraged as triggers for workflow automation. This oversight neglects a powerful metadata resource that could enable users to activate multiple workflows directly from a single email, thereby unlocking significant automation potential.

Platforms like Salesforce and HubSpot utilize recipient fields for basic tasks such as email tracking and logging customer engagement. However, these systems lack flexibility and primarily perform predefined actions on behalf of users. They do not allow for dynamic, multi-step workflows or user-defined automation, which limits their adaptability to specific organizational needs.

These limitations highlight a significant gap in the current automation landscape. Users and organizations require scalable, flexible solutions that can streamline complex processes, integrate seamlessly with existing tools, and offer real-time configurability to meet evolving business requirements.

BCCBuddy, the platform implementing this invention, addresses these limitations by transforming email metadata into dynamic triggers for user-configurable workflows. Users can simply include predefined email addresses, such as followup@bccbuddy.com or deal@bccbuddy.com, in the To, CC, or BCC fields of an email to initiate workflows. This approach eliminates the need for complex configurations or manual actions, empowering users to achieve bespoke automation tailored to their operational requirements.

### SUMMARY OF THE INVENTION

The present invention introduces a novel system and method for automating workflows triggered by recipient fields, including To, CC, and BCC fields, in emails. By leveraging these underutilized metadata fields, the system transforms email into a powerful driver for dynamic, multi-step workflow automation.

The invention includes an advanced email parsing engine to extract recipient metadata, including To, CC, and BCC fields. Each recipient address is treated as a unique trigger, enabling the initiation of workflows independent of the email's subject or body content.

Predefined email addresses, such as deal@bccbuddy.com or followup@bccbuddy.com, are mapped to specific workflows stored in a configurable storage system. These workflows are tailored to user-defined criteria and executed simultaneously, as illustrated in FIG. 3A and FIG. 3B.

The invention optionally incorporates Natural Language Processing (NLP) to analyze email content and extract actionable insights, such as deadlines or project names. These insights enhance workflow execution, ensuring adaptability to various operational scenarios, as depicted in FIG. 4.

Seamless integration with third-party platforms, including CRM tools, task management applications, and scheduling software, ensures scalability and operational efficiency. This integration, shown in FIG. 2, enables bi-directional communication with external systems for optimized workflow execution.

A user-centric configuration dashboard allows users to define and modify workflows based on their unique needs. Users can configure workflows to create CRM tasks, schedule follow-ups, or generate automated reports with minimal effort. This functionality is demonstrated in FIG. 5, which highlights user-defined workflow customization.

The invention empowers users to initiate workflows by simply including predefined email addresses in the To, CC, or BCC fields of an email. This approach eliminates the need for modifications to email content or additional user actions, ensuring seamless integration into existing email practices. By addressing the shortcomings of traditional systems, the invention redefines email automation, enabling scalability, flexibility, and user-specific customization across diverse industries and applications.

The present invention offers several distinct advantages over existing solutions, as demonstrated through comparisons to prior patents.

U.S. Pat. No. 7,065,493B1: Workflow System and Method: This patent describes a network-enabled workflow system driven by a rules-based search engine, which relies on predefined rules to identify workflows, making it heavily dependent on search engine operations. In contrast, the present invention leverages predefined workflows triggered dynamically via email recipient fields, including To, CC, and BCC fields. By eliminating the need for complex search engine operations, the invention's approach is intuitive, streamlined, and user-friendly. It enables faster deployment and simplified configuration, making it highly adaptable to user-specific requirements.

US20220182350A1: Systems and Methods for Email-Based Data Ingestion and Intelligent Workflows: This patent focuses on analyzing email content using natural language processing (NLP) to trigger workflows. While NLP is effective for extracting insights, its reliance on content parsing introduces constraints related to accuracy and complexity. Unlike this system, the present invention uses recipient fields as workflow triggers, bypassing the need for subject or body analysis. This ensures a simpler, more flexible implementation while maintaining the option for NLP as an enhancement rather than a dependency.

U.S. Pat. No. 9,264,393B2: Mail Server-Based Dynamic Workflow Management: This patent utilizes serial email propagation and response-based workflows, relying on sequential actions to execute workflows based on email responses. In contrast, the present invention enables parallel triggering of multiple workflows directly via predefined recipient fields. This parallel approach offers superior efficiency, scalability, and customization, allowing users to execute complex workflows simultaneously without waiting for responses.

US20210019707A: Workflow Service Email Integration: This patent describes embedding workflow micro-applications within email content, requiring active user interaction to initiate specific actions. For example, users must interact with embedded applications to perform certain tasks. The present invention operates seamlessly via recipient fields, requiring no changes to email content or interfaces. Automation occurs invisibly in the background, ensuring uninterrupted workflows and enhanced ease of use for both senders and recipients.

US20130166663A1: Workflow and In-Context Email Recipient Handling: This patent focuses on workflows tied to recipient roles within a specific email context, often requiring manual intervention to configure or initiate workflows. In contrast, the present invention leverages recipient fields, including To, CC, and BCC fields, as dynamic triggers for workflows, enabling simultaneous execution of multiple automated workflows. It eliminates the need for manual contextual handling or role-based configurations, providing a flexible and efficient solution.

By leveraging the underutilized To, CC, and BCC fields, the present invention transforms email into a dynamic tool for workflow automation. Unlike prior art that relies on static triggers or manual configuration, the invention enables automated, multi-step workflows triggered directly through recipient fields, ensuring seamless integration with standard email practices. This innovation requires no changes to email content or user behavior, offering unparalleled ease of use. The present invention represents a significant advancement in operational efficiency, scalability, and adaptability, addressing gaps in traditional systems and empowering businesses and individuals to streamline complex workflows effortlessly.

### BRIEF DESCRIPTION OF THE DRAWINGS

FIG. 1: System and Method for Workflow Automation Triggered by Recipient Fields: This figure illustrates the overall process flow, including email sending, metadata parsing, workflow identification, and execution. It highlights how recipient fields (To, CC, and BCC) are utilized as dynamic triggers for workflow automation.

FIG. 2: System Components Diagram: This figure outlines the system architecture, including modules for capturing email communications, parsing metadata and content, querying the storage system for workflow mappings, triggering predefined workflows, extracting actionable insights, integrating with third-party platforms, executing workflows, monitoring execution, and providing user-friendly configuration through a dashboard.

FIG. 3: This figure illustrates two interconnected components of the workflow system. FIG. 3A: Parsing Engine, a processing module configured to extract email metadata, analyze content, and identify workflow triggers primarily based on recipient fields (CC and BCC). FIG. 3B: Trigger Configuration, a configuration interface enabling users to define, modify, and manage workflow parameters, including trigger conditions, execution rules, and integration settings. The Parsing Engine references predefined rules stored in the Trigger Configuration to determine applicable workflows without direct, real-time data transfer. Together, these components facilitate dynamic mapping of email attributes to predefined workflows, ensuring fine-grained control over automation. The system optionally incorporates natural language processing (NLP) to extract actionable data from email content, further enhancing workflow execution.

FIG. 4: Dynamic Workflow Execution: This figure explains the execution of triggered workflows, including integration with third-party platforms, dynamic parameter handling, and monitoring of workflow execution.

FIG. 5: End-to-End User Journey: This diagram illustrates the user-centric simplicity of BCCBuddy, emphasizing seamless integration into existing email workflows without altering user behavior. Optional steps related to dashboard interaction demonstrate advanced customization, workflow configuration, and monitoring capabilities.

### DETAILED DESCRIPTION OF THE INVENTION

The present invention, referred to as BCCBuddy, introduces a novel system and method for workflow automation using email recipient fields (To, CC, and BCC). These fields, traditionally used for routing or metadata purposes, are dynamically transformed into actionable triggers for initiating and managing workflows. Unlike conventional approaches, which rely on static content or metadata, BCCBuddy enables simultaneous execution of multiple workflows from a single email, ensuring operational scalability and user-specific customization.

BCCBuddy integrates email systems with workflow management platforms and external systems to provide seamless workflow automation. In certain embodiments, the system functions as an intermediary layer facilitating communication between components, while in others, it operates as an embedded or standalone solution.

The system's functionality begins with parsing metadata from incoming emails using a Communication Reception Module 201, extracting recipient fields (To, CC, and BCC), timestamps, and other relevant headers. This metadata is then mapped to predefined workflows stored in a Workflow Mapping Database, where workflows are triggered based on user-defined rules. Depending on the configuration, workflows can be executed sequentially or in parallel, enabling users to handle complex, multi-step processes efficiently.

The present invention uniquely leverages recipient fields, including To, CC, and BCC fields, which are traditionally treated as passive metadata, as dynamic, user-configurable triggers for workflows. By utilizing predefined email addresses, such as deal@bccbuddy.com or followup@bccbuddy.com, the invention initiates workflows without relying on email content, such as subject lines or body text. This innovation redefines workflow automation by introducing a more efficient and adaptable approach.

The invention enables dynamic workflow execution by allowing the simultaneous triggering of multiple workflows from a single email. Recipient fields serve as distinct triggers, linking each address to predefined workflows stored in a configurable database, ensuring unparalleled flexibility and scalability.

The system supports seamless integration with external platforms, including customer relationship management (CRM) systems, task management tools, and scheduling applications. Through APIs or other integration mechanisms, workflows execute directly within third-party platforms, ensuring smooth communication and data synchronization.

The invention also offers user-specific customization through a configuration dashboard 508. The dashboard allows users to define, modify, and monitor workflows tailored to individual or organizational needs. This interface supports the creation of dynamic rules and real-time updates, enabling users to adapt workflows as business requirements evolve.

### TECHNICAL COMPONENTS AND ARCHITECTURE

The following sections detail the system's technical architecture, including the Communication Reception Module, Workflow Mapping Database, Integration Layer, and User Configuration Dashboard. Examples of use cases are provided to illustrate the system's operation in practical scenarios.

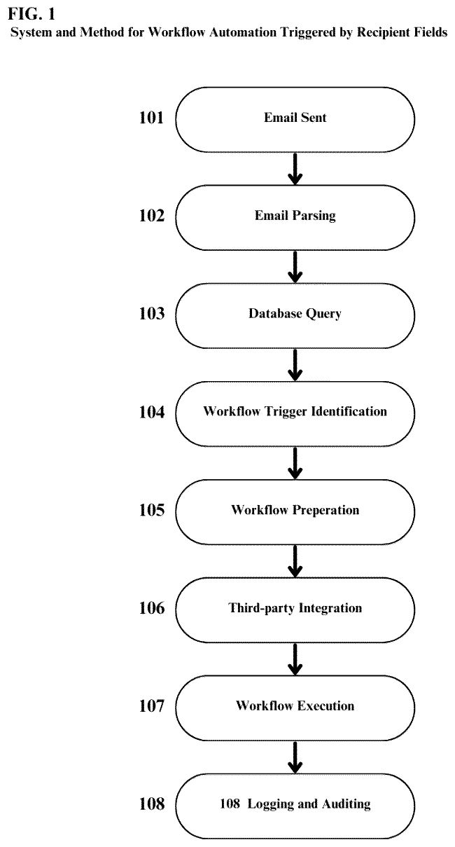

FIG. 1: Illustrates the workflow automation process initiated by emails.

Email Sent 101: An email is sent via SMTP, IMAP, or other email protocols by the user. The system intercepts the email for processing, preparing it for further steps in the workflow automation pipeline.

Email Parsing 102: The Email Parsing Engine processes the metadata and content of the email. It extracts sender and recipient details, including To, CC, and BCC fields, along with the subject line, email body, and any attachments included with the message.

Database Query 103: The system queries the storage system to check for known recipients, such as mapped To, CC, or BCC addresses. It also identifies existing records associated with the email, such as client history or prior workflows. Based on the query results, the system refines workflows by updating parameters or tasks and updates records with new insights extracted from the email.

Workflow Trigger Identification 104: The Workflow Mapping Module identifies the workflow trigger by matching the To, CC, or BCC addresses to predefined workflows stored in the Trigger Database. For example, the address logdeal@bccbuddy.com triggers the “Log Deal Workflow.”

Workflow Preparation 105: The Workflow Engine prepares the workflow by dynamically parameterizing tasks using insights derived from the email content, such as deal values and deadlines, as well as database records. It configures the tasks for seamless execution.

Third-Party Integration 106: The Integration Layer communicates with external systems via API calls to execute tasks. Examples of such tasks include logging deals in Salesforce, scheduling meetings in Google Calendar, and creating tasks with deadlines in Asana.

Workflow Execution 107: The requested actions are performed within the integrated third-party systems. The system monitors the execution of each task to ensure successful completion.

Logging and Auditing 108: The Workflow Engine records details of all actions performed, including execution timestamps, parameters used for each workflow, and the status of tasks (e.g., success or error). These details are stored in the Audit Database as part of the system's audit logs, providing a transparent and traceable record for monitoring and compliance purposes.

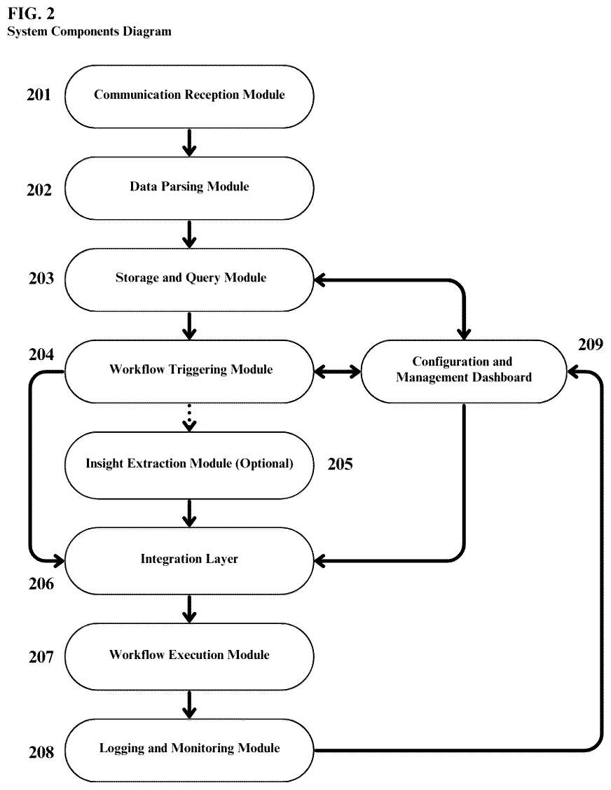

FIG. 2: Displays the system components facilitating automation.

Communication Reception Module 201: The Communication Reception Module captures incoming communications via any supported protocol or mechanism, such as SMTP, IMAP, HTTPS, or APIs. It extracts metadata from the communication, including sender information, recipients (e.g., To, CC, BCC, or equivalent fields), subject or header information, timestamps, and other contextual attributes. The module queues the communication for further parsing and processing by the Email Parsing Engine.

Data Parsing Module 202: The Data Parsing Module consists of two components: the Metadata Parsing Engine and the Content Parsing Engine. The Metadata Parsing Engine extracts header information, such as sender, recipients, and timestamps. The Content Parsing Engine analyzes the communication body and any associated attachments using rule-based approaches to identify predefined patterns or keywords, as well as AI, machine learning, or NLP techniques to extract actionable insights, such as deadlines, project names, or structured data.

Storage and Query Module 203: The Storage and Query Module access the Workflow Mapping Database, which serves as a storage system (e.g., centralized database, distributed storage, or in-memory system). This module checks whether communication metadata or content corresponds to predefined workflows and identifies existing records or workflows associated with the communication. Based on retrieved data, the module dynamically updates workflows with additional parameters, such as deal values or deadlines, and logs unmatched elements for manual review and future configuration.

Workflow Triggering Module 204: The Workflow Engine identifies triggers by mapping communication attributes, such as metadata, content, or contextual attributes, to predefined workflows stored in the Trigger Database. The module dynamically configures workflow parameters using data extracted from the communication and insights retrieved from storage systems or external sources.

Insight Extraction Module (Optional) 205: The Insight Extraction Module leverages AI and NLP to process unstructured or semi-structured data from the communication. It extracts actionable insights, including deadlines, priorities, next steps, client names, products, or services mentioned. These insights enhance workflows by refining triggers and parameters with the extracted data.

Integration Layer 206: The Integration Layer connects to external systems, such as CRMs, project management tools, and scheduling platforms, using APIs, webhooks, or other integration mechanisms. It executes tasks such as logging information in third-party systems, scheduling events, or creating tasks. Additionally, the Integration Layer manages confirmation of successful actions and handles errors with retries or alternative workflows.

Workflow Execution Module 207: The Workflow Execution Module initiates and manages workflows triggered by the system. It executes tasks across integrated platforms, supporting sequential or parallel execution. The module monitors and logs execution details, including task status (e.g., success or failure), errors encountered, and retries performed.

Logging and Monitoring Module 208: The Logging and Monitoring Module records details of workflow execution for traceability, including timestamps, parameters used in workflows, and execution statuses. It maintains accessible audit logs for debugging, compliance monitoring, and workflow optimization.

Configuration and Management Dashboard 209: The Configuration and Management Dashboard provides a user-friendly interface for defining, modifying, and managing workflows. It allows users to map communication attributes, such as metadata and content, to triggers; monitor errors and resolve issues; and configure integration settings, such as API keys or endpoints.

The dashboard facilitates data flows between various system components to ensure seamless configuration and monitoring. Updates to the storage module (209 to 203) include storing updated workflow mappings, configurations, and user-defined parameters for future use. The storage module (203 to 209) retrieves workflow definitions, configurations, and metadata for user reference or modification. The dashboard transmits updates to the Triggering Module (209 to 204), ensuring accurate execution of workflow triggers, definitions, and mappings. The Triggering Module (204 to 209) fetches existing workflow triggers and associated configurations for editing or user validation. Updated API keys, endpoints, integration configurations, or third-party platform details are transmitted to the Integration Layer (209 to 206) for execution. Additionally, the dashboard retrieves real-time log data from the Logging and Monitoring Module (208 to 209), including workflow execution details, errors, and system performance, which are displayed for analysis and transparency.

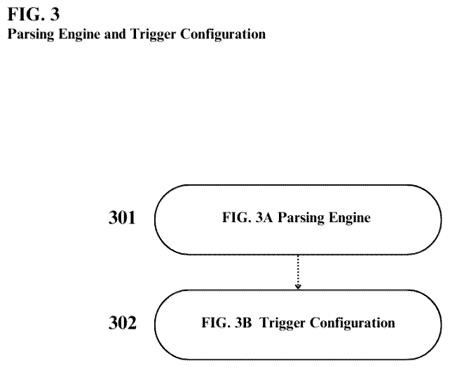

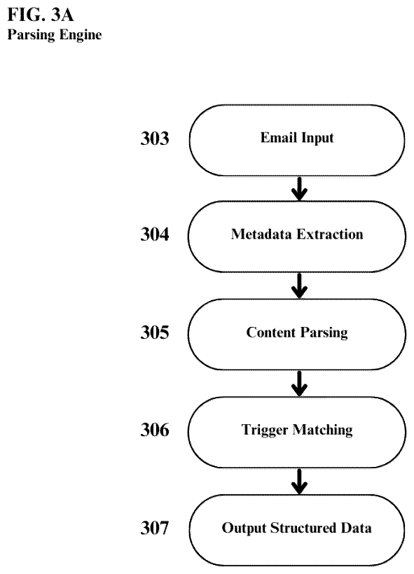

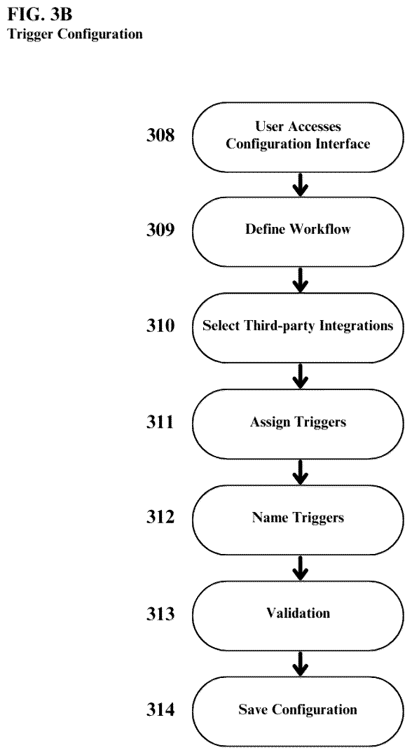

FIG. 3: This figure illustrates the two interconnected components of the workflow automation system: the Parsing Engine 301 and the Trigger Configuration 302. When an email is received, the Parsing Engine references rules predefined by users and stored in the Trigger Configuration to match email recipients (primarily CC/BCC fields) and keywords to their associated workflows, determining which workflows to initiate. The dotted arrow from Parsing Engine 301 to Trigger Configuration 302 indicates that the Parsing Engine references predefined trigger rules stored in the Trigger Configuration without implying direct, real-time data transfer between these components.

FIG. 3A: Parsing Engine

Email Input 303: The system receives an email via SMTP, IMAP, or other email protocols and processes it directly through the Parsing Engine without requiring user intervention.

Metadata Extraction 304: The Metadata Parsing Engine extracts essential header metadata from the email, including the sender's email address, recipient email addresses from the To, CC, and BCC fields, the subject line, and the timestamp of the email. The extracted metadata is temporarily stored for further analysis and workflow mapping.

Content Parsing 305: The Content Parsing Engine analyzes the email body and, optionally, any attached files to identify actionable content. The engine detects predefined keywords or phrases, such as “Create task,” “Schedule meeting,” or “Deadline: [date],” using rule-based methods or Natural Language Processing (NLP) algorithms. The engine may also parse attachments, such as PDFs or spreadsheets, to extract relevant data, including deadlines, project details, or client information.

Trigger Matching 306: The Trigger Matching Engine compares extracted metadata and content against predefined trigger definitions stored in the storage system. Triggers are identified based on recipient fields, such as To, CC, and BCC addresses, or keywords found in the email subject or body. For example, an email sent to logdeal@bccbuddy.com triggers the “Log Deal Workflow.” If multiple triggers are identified, the system applies prioritization rules, such as priority order or time sensitivity, to select the appropriate workflows.

Output Structured Data 307: The Parsing Engine converts the parsed email into a structured data format, such as JSON, to facilitate integration with the Workflow Execution Module. The structured data includes extracted metadata, identified triggers, and relevant parameters, such as deadlines or task descriptions, which are essential for workflow execution. For example, the structured output may include details such as the sender, recipients, subject line, timestamp, associated triggers, and keywords extracted from the email. An illustrative representation of such an output is provided below:

JSON{ “sender”: “user@example.com
”, “recipients”: [“logdeal@bccbuddy.com”, “manager@example.com
”], “subject”: “Quarterly Update”, “timestamp”: “2024-12-30T10:00:00Z”,
“triggers”: [“Log Deal Workflow”], “keywords”: [“Create task”,
“Deadline: 2024-12-31”] }

FIG. 3B: Trigger Configuration

User Accesses Configuration Interface 308: The user accesses a visual or text-based interface to manage workflows. Unlike traditional systems, this interface allows non-technical users to create dynamic automation rules without requiring scripting or API-level knowledge.

Define Workflow 309: Users create or edit workflows by specifying the tasks to execute, such as logging a deal, scheduling a meeting, or creating a task. Task parameters, including deadlines, assignees, and custom task descriptions, can also be configured. The system's modularity allows workflows to be tailored to the needs of individual users or teams.

Select Third-Party Integrations 310: Users can associate workflows with multiple third-party platforms, such as Salesforce, Asana, or Google Calendar. The system supports configuring multiple integrations per workflow, enabling a single email to trigger actions across different systems. This flexibility eliminates the need for additional technical setup and ensures seamless integration.

Assign Triggers 311: Users map email attributes to workflows. Triggers are primarily based on CC and BCC recipient fields—such as logdeal@bccbuddy.com triggering a “Log Deal Workflow”—although they can optionally also include To fields, keywords, or phrases in the email subject or body. This combination of metadata and content-based triggers provides fine-grained control over workflow automation.

Name Triggers 312: Users assign descriptive names to triggers, making it easier to organize and track workflows. This feature enhances usability, enabling efficient management of multiple workflows.

Validation 313: Before saving, the system validates workflows and triggers to ensure their reliability. Validation steps include checking for unique triggers, such as avoiding duplicate To, CC, or BCC mappings, and verifying compatibility with third-party integrations. This process minimizes errors during execution.

Save Configuration 314: The system saves user-defined workflows, triggers, and integration preferences in the storage system. These configurations are then accessible to the Parsing Module, which dynamically maps incoming emails to workflows and adjusts task parameters or integrations based on user-defined rules. By centralizing configuration and execution, the system bridges the gap between user customization and automated workflow execution.

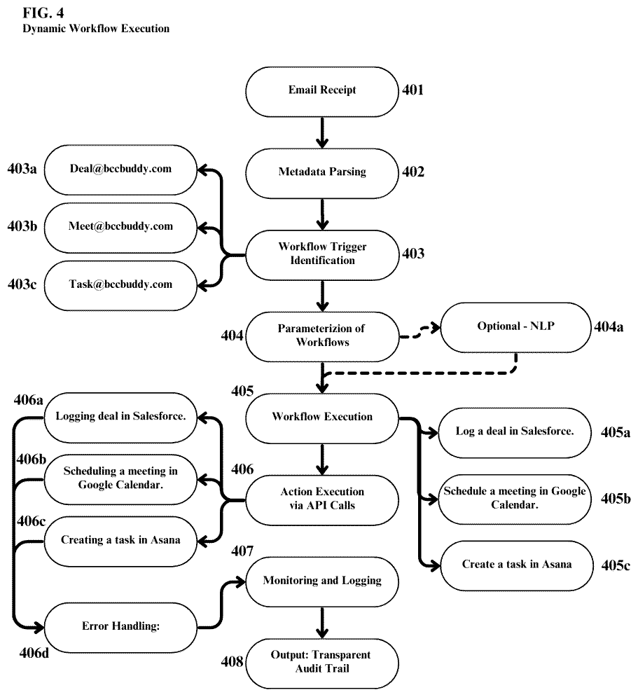

FIG. 4: Showcases the dynamic workflow execution process.

Email Receipt 401: Upon receipt of an email, the system captures metadata, including the sender, recipients (To, CC, BCC), subject line, email body, and optional attachments. The timestamp of the email is also recorded to enable workflow logging and traceability.

Metadata Parsing 402: The system processes the captured metadata to extract essential details, such as the sender's email address and name, recipient addresses in the To, CC, and BCC fields, and the subject line. The timestamp is used to ensure workflow traceability and logging.

Workflow Trigger Identification 403: The system queries the Trigger Database to match recipient fields, including To, CC, and BCC fields, with predefined workflows stored in the database. Upon identifying a match, the system retrieves the configuration details associated with each workflow. For example, 403a the email address deal@bccbuddy.com triggers the “Log Deal Workflow,” 403b meet@bccbuddy.com triggers the “Schedule Meeting Workflow,” and 403c task@bccbuddy.com triggers the “Create Task Workflow.” This ability to dynamically map recipient fields to customizable workflows represents a novel aspect of the system, enabling flexible and scalable automation tailored to user-defined criteria.

Parameterization of Workflows 404: The system dynamically enriches workflows with parameters derived from email content, enabling enhanced precision and adaptability in workflow execution. As part of this process, the system parses the email's content, including the subject, body, and any attachments, to extract parameters such as client names, project details, or task deadlines. This extracted data is directly used to refine and tailor workflow execution to specific operational requirements.

The system optionally incorporates Natural Language Processing (NLP) 404a to further enhance parameterization by extracting actionable data, such as client names, deadlines, or specific instructions, from the email body. For example, in the sentence, “Schedule a call with Client X next Friday,” the NLP module identifies and extracts “Client X” as the client name and “next Friday” as the deadline to populate workflow parameters. This optional step, as indicated in diagrams, offers flexibility and adaptability to accommodate various implementation scenarios while improving the relevance and efficiency of automated workflows.

Workflow Execution 405: The system initiates the corresponding workflows for each matched trigger. Workflows can be configured for either sequential or parallel execution, depending on user-defined settings and operational requirements. Examples of workflows include 405a logging a deal in Salesforce, 405b scheduling a meeting in Google Calendar, and 405c creating a task with a specific deadline in Asana. These workflows are dynamically executed based on the triggers identified during the parsing and configuration process, ensuring flexibility and scalability.

Action Execution via API Calls 406: The system communicates with integrated third-party platforms through API requests to execute the specified actions. For example, 406a the system may log a deal in Salesforce using extracted parameters, 406b schedule a meeting in Google Calendar, or 406c create a task in Asana with a predefined deadline. The system also incorporates 406d robust error handling mechanisms, logging errors, retrying actions based on predefined retry policies, and escalating unresolved issues to the user through the User Dashboard. This ensures reliability and provides transparency in the execution process.

Monitoring and Logging 407: The system tracks workflow execution details to provide transparency and traceability. Logged data includes execution timestamps, parameters used in workflows, task statuses (e.g., success, failure), and errors encountered. The system generates a real-time dashboard for monitoring active and completed workflows.

Output: Transparent Audit Trail 408: The final deliverable is a consolidated audit trail stored in the Audit Database. This trail provides transparency for workflow execution, compliance with organizational policies, and traceability for debugging and optimization. The audit trail ensures that all actions performed by the system are documented and accessible for review.

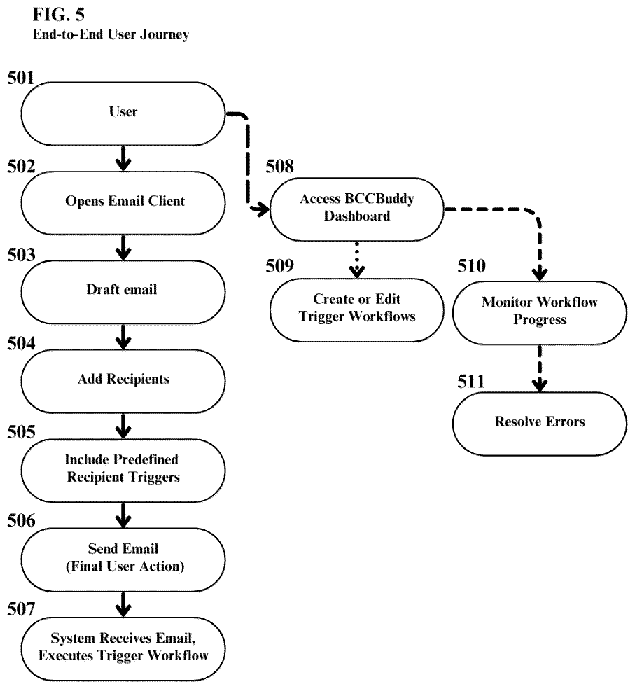

FIG. 5: Highlights the user journey through BCCBuddy.

User 501: Users can engage with BCCBuddy through various platforms, including email clients such as Gmail and Outlook, BCCBuddy's Dashboard, or other integrated systems. The interaction method depends on the user's workflow requirements.

Open Email Client 502: The user launches an email client, such as Gmail or Outlook. At this stage, no direct interaction with the BCCBuddy system occurs, but this marks the starting point for workflow automation.

Draft Email 503: The user composes the email content, including the subject line, body, and optional attachments. The system does not modify the drafting process but prepares to intercept email metadata once the email is sent.

Add Recipients 504: The user specifies recipients in the appropriate email fields, including the To field for primary recipients, the CC field for secondary recipients visible to all, and the BCC field for secondary recipients hidden from other recipients. These fields allow for precise delivery of email content to the intended parties while accommodating additional automation triggers.

Include Predefined Recipient Triggers 505: The user can include predefined email addresses in the To, CC, or BCC fields to initiate specific workflows. For example, entering logdeal@bccbuddy.com triggers the “Log Deal Workflow,” while meet@bccbuddy.com triggers the “Schedule Meeting Workflow.” Utilizing the BCC field as a workflow trigger minimizes email clutter by maintaining automation processes discreetly and preserves recipient privacy without interfering with the primary purpose of the email.

Send Email 506: The user sends the email, initiating delivery to the system. This step represents the final action by the user in the email workflow process.

System Receives Email and Executes Workflow Trigger 507: The BCCBuddy system receives a copy of the email through the To, CC, and/or BCC fields. When listed in the To or CC fields, BCCBuddy acts as a visible recipient of the email. When included in the BCC field, BCCBuddy receives a blind copy, maintaining the privacy of the recipient. Upon receipt, the system securely processes the email metadata and content without altering the email's original delivery. The system passively intercepts the email via standard email protocols and ensures that the primary transmission to other recipients remains unaffected.

Access BCCBuddy Dashboard (Optional) 508: Users can log into the BCCBuddy dashboard via secure authentication to manage workflows.

Create or Edit Trigger Workflows (Optional) 509: This dashboard allows users to create or edit workflows by associating specific To, CC, or BCC addresses with tasks. For example, a user can update the workflow linked to logdeal@bccbuddy.com to include additional data fields. These updates are stored in the centralized Trigger Database and applied to subsequent emails.

Monitor Workflow Progress (Optional) 510: The dashboard includes tools that allow users to monitor and manage workflow execution effectively. Users can track completed workflows, review errors or flagged actions, and access real-time logs that provide detailed insights into system performance. These features enhance transparency and allow users to identify and address potential issues efficiently.

Resolve Errors (Optional) 511: If issues arise, the system provides error details and suggested resolutions via the dashboard. Users can address flagged issues, such as retries for failed API calls.

### EXAMPLES

Scenario 1: A sales representative sends an email to a prospect and includes the BCC addresses deal60@bccbuddy.com and followup4@bccbuddy.com. Upon receipt of the email, the system identifies the triggers associated with these recipient addresses and executes the corresponding workflows. For the deal60@bccbuddy.com trigger, the system creates a new deal in Salesforce, associates it with the prospect's account, and sets the probability to 60%, as defined in the user-configured workflow. Using the NLP engine described in FIG. 2, the system extracts the deal value and timeline from the email content to enrich the CRM record. For the followup4@bccbuddy.com trigger, the system initiates a follow-up workflow that schedules a reminder email to be sent to the sales representative four days later. The sender simply includes the BCC addresses, and the system automates all associated processes without requiring modifications to the email content or format. The primary recipient remains unaware of the automated actions, ensuring a transparent and seamless workflow. This example demonstrates the integration of email parsing and workflow execution, as described in FIG. 4, combined with user-defined configurations outlined in FIG. 5.

Scenario 2: Task Management with Multiple Triggers: A project manager sends an email to their team, including task10@bccbuddy.com and notify@bccbuddy.com in the CC field. Upon receipt of the email, the system creates a task in Asana, using the email subject as the task title. The task is automatically assigned to the team members listed in the CC field of the email, and a deadline of 10 days is applied based on the predefined task 10 workflow. Additionally, the system triggers a Slack notification to the project lead through the notify@bccbuddy.com workflow. This automated process is facilitated by the data parsing module described in FIG. 2 and the trigger configuration workflow illustrated in FIG. 3B.

Scenario 3: Scheduling Meetings: A user proposes a meeting in an email and CCs schedule@bccbuddy.com and reminder@bccbuddy.com. Upon receipt of the email, the system analyzes the email content to extract meeting details and participants using the Insight Extraction Module 205 described in FIG. 2. It creates a meeting event in Google Calendar, resolves scheduling conflicts dynamically, and sends calendar invitations to participants. The system sends a reminder, via reminder@bccbuddy.com, one day before the meeting. The sender does not need to format the email or follow specific templates, as the system automatically identifies and processes relevant details. The workflow execution and third-party integration described in FIG. 4, along with user-defined workflows in FIG. 3A and FIG. 3B supports this process.

### OPTIONAL FEATURES AND ENHANCEMENTS

Browser and Email Platform Integration: User accessibility and workflow customization may be enhanced through integration with web browsers and email platforms. Browser extensions for Chrome, Firefox, or Edge could provide quick access to workflow creation and monitoring, while in-app tools for mail providers such as Gmail and Outlook could enable workflow customization directly within the email environment further enhancing the user journey.

Cross-Device Compatibility: Seamless usability across devices may be achieved through mobile apps or responsive dashboards that allow users to configure and monitor workflows. The system could synchronize workflows and updates across devices in real-time. For example, a user could configure workflows on a desktop and receive status updates or reminders on a mobile device.

AI-Driven Agents: AI agents can enhance workflow intelligence by enabling dynamic decision-making and process refinement. These agents may interact with external systems to gather additional data and optimize workflow execution. For instance, an AI agent could identify an incomplete task from a previous workflow and integrate it into a newly triggered workflow.

BCCBuddy's capabilities may expand to address consumer-focused applications by integrating with platforms such as Venmo for payment reminders, Airbnb for booking automation, and travel booking sites for itinerary tracking and notifications. These integrations would enable consumers to create reminders for personal tasks, including payment deadlines and travel arrangements. For instance, the system could automatically log an Airbnb booking into a calendar and generate a reminder to request payment from specified recipients in the To or CC fields, streamlining the coordination process.

Real-time insights and suggestions can optimize workflows using machine learning models. The system can analyze workflow efficiency and recommend updates to streamline processes. For instance, the system can suggest consolidating workflows or modifying triggers based on recurring patterns in email usage.

### CONCLUSION

The present invention, referred to as an Automated Workflow Management System Triggered by Email Recipient Fields, introduces a novel method for email-triggered workflow automation. By leveraging recipient fields, including To, CC, and BCC, traditionally used only for email delivery, the system initiates dynamic, multi-step workflows, transforming email into a robust tool for seamless and scalable automation across diverse industries and applications.

This invention combines advanced parsing techniques, a centralized workflow mapping database, and third-party platform integrations to enable simultaneous execution of multiple workflows based on predefined configurations. Optional features, such as natural language processing (NLP), AI-driven insights, and extensibility for consumer-oriented applications, enhance the system's adaptability to evolving user requirements.

Applications range from enterprise-level automation in sales, marketing, customer support, and human resources to consumer-focused use cases such as group bookings and payment processing. The system's intuitive configuration dashboard, robust error-handling mechanisms, and compliance with data protection standards ensure accessibility for both technical and non-technical users.

By addressing the limitations of existing automation solutions, this invention redefines operational efficiency, scalability, and user-centric design. Its unique ability to automate workflows through recipient fields positions it as a transformative solution for individuals and organizations alike, making email a central driver of productivity and collaboration.

In summary, BCCBuddy integrates seamlessly with existing email practices, requiring no additional work from senders or recipients. Senders and recipients can continue using email as usual, with no need to modify email content or attach special instructions. Workflows are triggered dynamically based on email metadata, not the subject, body, or attachments. All automation occurs transparently in the background, ensuring a frictionless experience for both senders and recipients. This functionality is supported by the dynamic workflow execution process described in FIG. 1 and FIG. 4, combined with user-configured workflows as shown in FIG. 5.

The invention claimed is:

1. A system for automating workflows triggered by email recipient fields, including To, CC, and BCC fields, comprising an email parsing engine configured to extract metadata from an incoming email, including recipient fields; a workflow mapping module that maps recipient fields to predefined workflows stored in a user-configurable storage system; an integration layer configured to execute multi-step workflows across third-party platforms using customizable APIs or predefined integration rules, enabling simultaneous execution of multiple workflows triggered by distinct recipient fields; a configuration dashboard enabling users to define, modify, and monitor workflows associated with specific recipient fields; and a failure recovery mechanism to retry or log failed workflow executions for reliability, wherein the system optionally incorporates natural language processing (NLP) to extract actionable data, such as task descriptions, deadlines, or priorities, from the email body to enhance workflow execution without relying solely on email content.

2. A method for automating workflows using recipient fields in emails, comprising parsing email metadata to identify recipient fields, including To, CC, and BCC fields; mapping each identified recipient field to a specific workflow stored in a centralized, user-configurable storage system; executing the mapped workflows, including multi-step tasks, across one or more third-party platforms to maintain integrity through sequential, conditional, or parallel execution where applicable; optionally extracting contextual data, including task descriptions, deadlines, or sentiment, from the email body using natural language processing (NLP) to enhance workflow outputs; generating an audit log for each executed workflow, including timestamps and workflow outputs for transparency and compliance purposes; and providing a user interface for configuring workflows, monitoring their execution, and dynamically updating, modifying, or disabling workflows in real-time based on system feedback or user intervention.

3. A system for dynamic multi-trigger workflow execution, wherein multiple recipient fields, including To, CC, and BCC fields, within a single email independently trigger distinct workflows simultaneously; each triggered workflow supports branching logic defined by parameters such as metadata, recipient roles, extracted data, or user-defined conditions stored in the storage system; the system dynamically updates workflows based on user-defined parameters and ensures compliance with role-based access control; and an optional email interface integration displays workflow summaries and requests user confirmation before execution.

4. A system for automated workflow management triggered by email recipient fields, including To, CC, and BCC fields, comprising a configuration dashboard enabling users to define workflows using customizable parameters, including triggers, conditions, and actions; modify or disable workflows in real-time without disrupting other ongoing processes; a feedback mechanism integrated into the user interface to allow users to validate, approve, adjust, or override workflow execution dynamically based on system recommendations or manual inputs; and a transparency module that provides users with a detailed log of triggered workflows and their execution status and notifications for actions requiring manual approval or intervention, wherein the system prioritizes user-defined configurations over default settings to ensure a tailored workflow experience and support both novice and advanced users through role-based access and guided configuration tools.

5. The system of claim 1, wherein workflows triggered by recipient fields include actions such as updating records in customer relationship management (CRM) systems, creating and assigning tasks in project management tools, scheduling follow-up communications or meetings, and logging resource requests in procurement systems.

6. The system of claim 1, wherein the integration layer connects to external systems via APIs, supporting platforms such as Salesforce, Asana, Google Workspace, and Zendesk.

7. The system of claim 1, wherein workflows triggered by BCC recipients are prioritized over those triggered by CC or To recipients based on user-defined configurations or system preferences.

8. The system of claim 1, further comprising a distributed computing framework to handle emails with hundreds of recipient fields concurrently without performance degradation.

9. The system of claim 1, wherein the configuration dashboard supports role-based access control to restrict workflow creation and modification to authorized users and notifications to users regarding workflow execution status.

10. The method of claim 2, wherein the email parsing engine filters emails based on preconfigured criteria, such as sender, domain, or subject line, before identifying recipient fields.

11. The method of claim 2, wherein NLP capabilities are used to extract data points such as deadlines, task descriptions, and sentiment analysis to prioritize customer support workflows.

12. The method of claim 2, further comprising dynamically disabling workflows for specific recipients based on updated user-defined criteria in the configuration dashboard.

13. The method of claim 2, wherein workflows triggered by recipient fields are monitored through an optional email interface popup displaying a summary of triggered workflows.

14. The system of claim 1, wherein all workflows and data exchanges are encrypted using industry-standard encryption protocols suitable for ensuring data confidentiality and compliance with applicable data protection regulations.

15. The system of claim 1, wherein the email parsing engine supports integration with enterprise-grade email systems, including Microsoft Outlook, Google Workspace, and Slack email connectors.

16. The system of claim 1, further comprising leveraging email metadata beyond recipient fields by parsing the “To” field, subject lines, and custom headers to trigger user-specific workflows that are stored in a centralized or distributed database.

17. The method of claim 2, wherein workflows are triggered by analyzing attachment types, file content, or email headers in addition to recipient fields.
